(19) United States
(12) Patent Application Publication
(10) Pub. No.: US 2014/0122579 A1
(43) Pub. Date: May 1, 2014

(54) WEB-BASED METHOD FOR PHYSICAL OBJECT DELIVERY THROUGH USE OF 3D PRINTING TECHNOLOGY

(71) Applicant: Layer By Layer, Inc., Sunnyvale, CA (US)

(72) Inventors: Max David Friefeld, Long Beach, CA (US); Jonathan Miller Schwartz, New York, NY (US); Oliver Martin Ortlieb, Escondido, CA (US); Carl Pearson, Champaign, IL (US)

(73) Assignee: LAYER BY LAYER, INC., Sunnyvale, CA (US)

(21) Appl. No.: 14/066,222

(22) Filed: Oct. 29, 2013

Related U.S. Application Data
(60) Provisional application No. 61/721,431, filed on Nov. 1, 2012.

(51) Int. Cl. H04L 29/08

(52) U.S. Cl. CPC H04L 67/06
USPC 709/203

(57) ABSTRACT

A system allows for the delivery of products through the use of 3D printing technology, enabling a non-technical user to locate, select, and print a product with minimal effort. The system provides a listing of one or more 3D object files for display to a user at a client machine. Once a user selects one or more 3D object files, the system establishes a network connection between the online server and the client 3D printer and then streams the selected 3D object file from the online server to the 3D printer in a format supported by the 3D printer. The system may also process received 3D object files to produce a plurality of formatted 3D object files, each formatted 3D object file converted to a format based on the received set of printing parameters and a set of capabilities for a different 3D printer of a plurality of 3D printers.

### TECHNICAL FIELD

The subject matter described herein relates to systems and techniques for the web-based delivery of products from an online server to a 3D printer, where the products are manufactured.

### BACKGROUND

Additive manufacturing, also known as 3D printing, is a technology that allows for the creation of products through the process of putting material together, as opposed to cutting it away through a subtractive manufacturing method. Complex and unique objects can be manufactured with 3D printing, which would not be possible with traditional manufacturing methods.

Today, personal 3D printing technology grants households access to sophisticated manufacturing techniques that allow users to build their own products. This technology can be used for many applications such as rapid prototyping or finished part production. The rise of personal 3D printing has given consumers the ability to purchase and manufacture products without ever having to leave home. However, using a 3D printer requires a 3D object file and an associated set of parameters that control the manufacturing process on the 3D printer. Creating a 3D object requires a significant amount of skill and time. Because the average consumer does not necessarily have the required skill, time, or desire to design their own products, they need a way to easily obtain 3D object files for printing. The parameters associated with a 3D object file also require a certain amount of skill to determine, and often have a very significant impact on the quality and functionality of the final manufactured object. The complexity of using a 3D printer and its associated software creates a barrier to entry for any non-technical user wishing to benefit from 3D printing technology.

### SUMMARY

The system and techniques described herein allow for the web-based delivery of products through the use of 3D printing technology. The current subject matter makes it possible for a non-technical user to locate, select, and print a product with minimal effort. As well, the system minimizes the Client's access to a product's 3D object file—making it difficult to pirate and distribute the product illegally.

The details of one or more variations of the subject matter described herein are set forth in the accompanying drawings and the description below. Other features and advantages of the subject matter described herein will be apparent from the description and drawings.

### DESCRIPTION OF DRAWINGS

FIG. 1 is a diagram illustrating an embodiment of the invention described herein;

FIG. 2 is a diagram of one system for uploading 3D object files and associated data and information to a server;

FIG. 3 is a flow diagram illustrating a user-interface process for uploading products to a server;

FIG. 4 illustrates a product file and information entry mechanism in one embodiment;

FIG. 5 illustrates one product's organization through a grouping interface in one embodiment;

FIGS. 6 and 7 are diagrams illustrating two embodiments of systems to purchase and deliver products using a 3D printer;

FIG. 8 is a flow diagram illustrating a process for streaming digital product information from a server to a Client application;

FIG. 9 is a diagram illustrating one embodiment of a system for streaming digital product information from a Client application to a Client 3D printer.

### DETAILED DESCRIPTION

The subject matter described herein represents a system that can be used to deliver 3D object files, or products, to a User through the use of 3D printing technology. The System has two main benefits; simplifying the procedure required to use a 3D printer, and the ability to limit a User's access to the actual 3D object file(s) used in the delivery and manufacturing process.

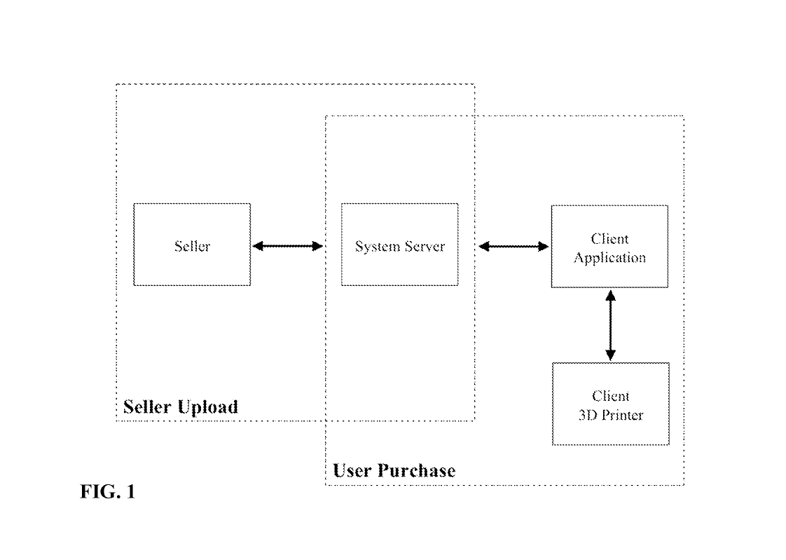

The System described herein, represented as an online marketplace, can be embodied by two sub-systems as seen in FIG. 1: (a) Seller Upload, and (b) User Purchase. This embodiment as a marketplace is only one of many, as others may include similar and/or different sub-systems used to achieve the same System purposes, and may or may not be represented as an online marketplace.

System: The summation of the methods and techniques described herein to create a delivery method for physical products using 3D printing technology.

Marketplace: A single embodiment of the system described herein, where products are bought and sold.

User: Any entity that uses the services described herein.

Client: A machine belonging to a User (e.g. a computer or 3D printer).

Client Application: Software run on a Client machine, which may be used to communicate with the System server and the Client 3D printer.

3D Object File: A computer-file that holds 3D data that represents a 3D object, which may be manufacturable by a 3D printer.

Product: A 3D object that may have 3D object files, information, and manufacturing parameters associated with it.

Seller: A User that uploads products and information through the Seller Upload process described herein.

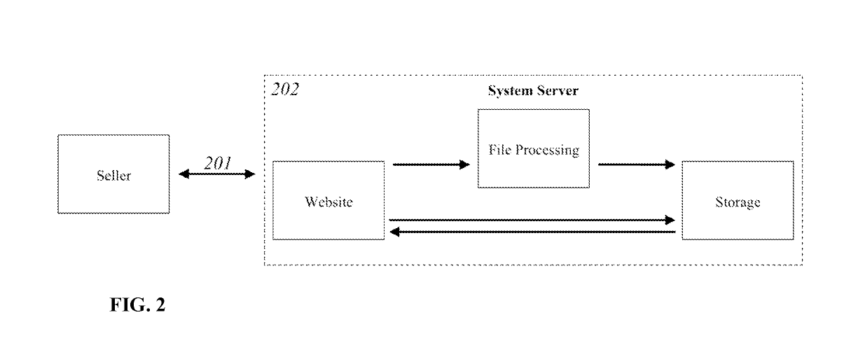

Seller Upload: As illustrated in FIG. 2, the Seller Upload process begins when a Seller wishes to upload a product's 3D object file(s). A Seller may post a product for sale on the Marketplace through the Seller User-Interface (201) that accepts User and product information. The Seller Upload process ends once the Seller-uploaded product information and 3D object file(s) complete the File Processing and Storage process (202), which may or may not result in the posting of the product on the Marketplace.

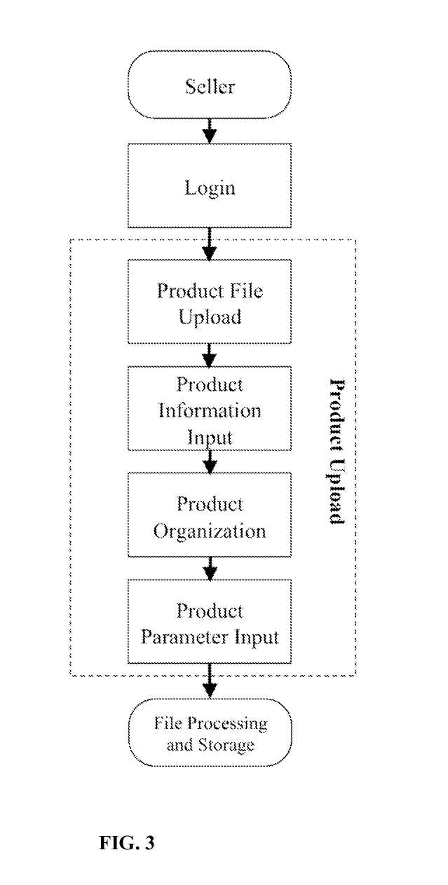

Seller User-Interface: As illustrated in FIG. 3, the Seller User-Interface provides Sellers with access to the Login and Product Upload processes.

Login: Existing or new Users can log in or create an account by providing their basic information, which may include, but is not limited to, username, password, email address, and payment/billing information.

Product Upload: The Product Upload process results in the File Processing and Storage process, which may later result in the posting of a product on the Marketplace. The Product Upload process may include, but is not limited to, the Product File Upload, Product Information Input, Product Organization, and Product Parameter Input processes.

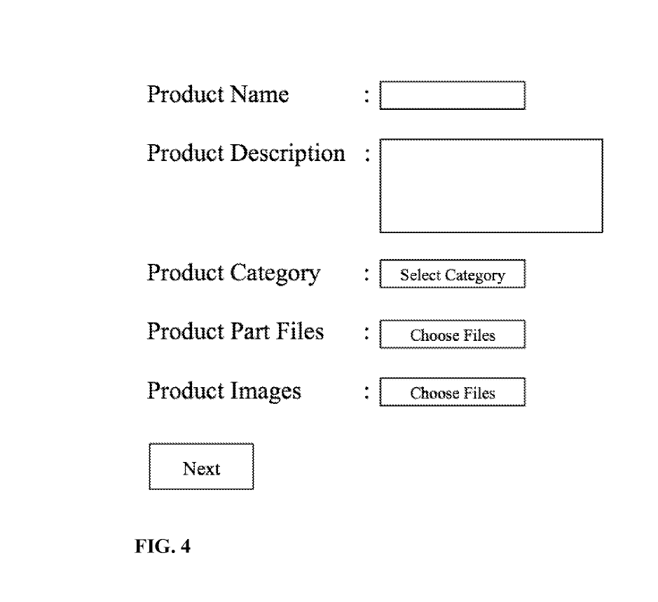

Product File Upload: As illustrated in FIG. 4, the Seller is prompted to upload the 3D object file(s) associated with the product that is being uploaded. A single product may be comprised of one or more separate parts, and thus may require one or more 3D object files. An online interface is a single example of where Product File Upload may occur, although other embodiments exist such as through a Client software application.

Product Information Input: As illustrated in FIG. 4, the Seller is prompted to input information pertaining to the product that is being uploaded. This may include, but is not limited to, the product name, a product description, product price, and any product photos.

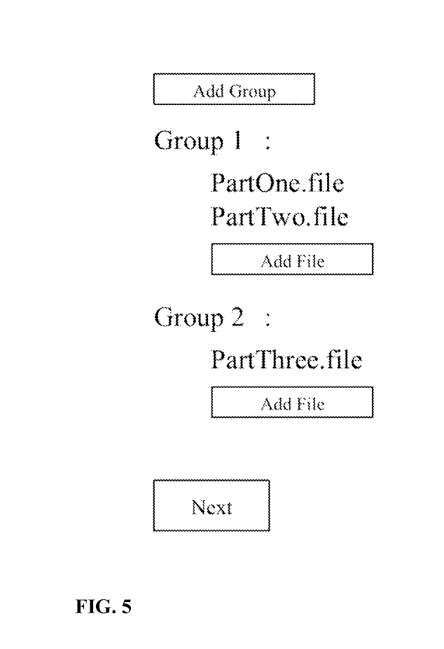

Product Organization: The Product Organization process can be used for products that are comprised of multiple parts, or more than one 3D object file. This process allows a Seller to group the parts of a product based on specific manufacturing requirements or constraints that should apply to specific parts of a product. These may be manufacturing parameters, colors, materials, quantities, or any other manufacturing variables. FIG. 5 illustrates one example of a product's part organization through the Product Organization form, where a Seller can upload specific parts or files, and organize them into groups, which at any time may have specific manufacturing variables attached.

Product Parameter Input: The Product Parameter Input process allows a Seller to input all of the parameters associated with the product being uploaded. These parameters influence the 3D Object File Processing and product manufacturing processes, and thus affect the functionality and quality of the final delivered product. The Seller may upload multiple sets of parameters, which may be applied to specific groups of parts as dictated by the Product Organization.

File Processing and Storage: After a Seller has finished the Product Upload process, all information and 3D object files associated with the product can be processed and stored through the 3D Object File Processing and Product Storage processes. These may or may not be included in alternative embodiments.

File Processing and Storage Alternative: In one alternative, the Seller-uploaded product files and information may be stored through Product Storage without being processed through 3D Object File Processing. If at any time the product's associated 3D object files require processing, it may be done at the time of request on the System server, in the Client Application, or directly on the Client 3D printer after being removed from storage.

3D Object File Processing: Using a specialized compiler, uploaded 3D object files will be processed and compiled into file formats that can be interpreted by Client 3D printers. The compiler may use Client 3D printer specifications, the Seller-uploaded product parameters, and the Product Organization to process these 3D object files. Printer specifications are properties of a 3D printer (e.g. build volume, material type, minimum layer height, etc.) that may vary across different 3D printers. In the case that System supported 3D printers have varying specifications, the compiler may create separate files for each 3D printer to be stored through the Product Storage process. For example, a Seller-uploaded .STL file may be processed and compiled into the standard g-Code file format that is interpretable by certain 3D printers. One implementation may involve performing this processing on the System server, although Client-side processing or other methods can also be used.

3D Object File Processing Alternate: In one alternative embodiment, the compiler used to process and compile the 3D object files may additionally accept parameters from the User during the User Purchase process. These parameters may then be used solely, or in conjunction with the Client 3D printer specifications and the Seller-uploaded product parameters to complete the 3D Object File Processing as described herein.

Product Storage: Before 3D Object File Processing, the original 3D object file(s) and Product Information are able to be stored on the System server for later retrieval. After any 3D Object File Processing, the resulting processed file(s) are also stored for later retrieval.

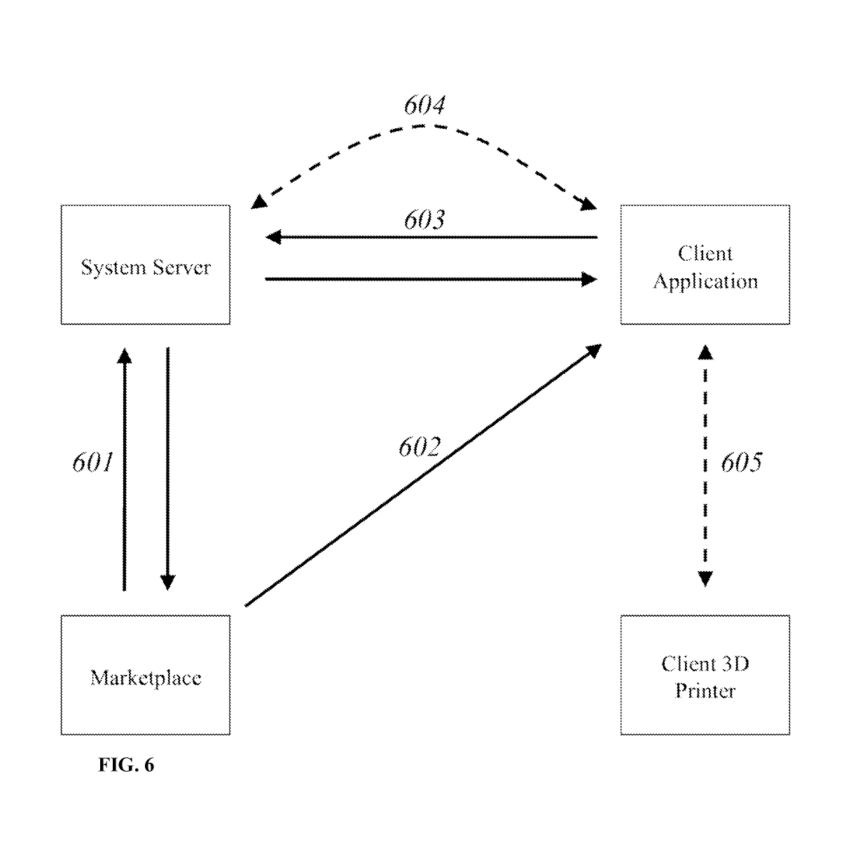

User Purchase: The User Purchase process allows Users to obtain products from the Marketplace. The process begins with the selection of a product on the Marketplace and ends with the delivery of the physical product using a Client 3D printer. As illustrated in FIG. 6, the process may include, but is not limited to, the Purchase User-Interface (601), Client Application Call (602), Session Validation (603), and Product Delivery (Server File Stream 604 and Client Application File Stream 605) processes. This embodiment is only one of many, as others may include similar and/or different processes used to achieve Product Delivery.

Purchase User-Interface: The Purchase User-Interface allows a User to input information relating to the purchase and delivery of a product. It provides Users with access to processes that may include, but are not limited to, Product Selection, Login, Printer Selection, and Purchase Confirmation.

Product Selection: Through the Marketplace, a User may navigate to a product page that displays a product and its information, which may include, but is not limited to, price, description, and photos. Through this page a User can initiate a User Purchase of a product.

Printer Selection: At any point during the User Purchase process, a User may be prompted by a Printer Selection page to choose the type of 3D printer that will be used to manufacture the product. This page will display all of the printers that are supported by the System and are capable of manufacturing the product being purchased. The User may then select the printer from this list that will be used for Product Delivery. For example, this may be done through the Marketplace before Purchase Confirmation, or through the Client application before Product Delivery is initiated.

Purchase Confirmation: In the Purchase Confirmation process, User actions may include, but are not limited to, confirming, delaying, or canceling the purchase of a product. If the User confirms the purchase, the transaction will be registered within the System and a Client Application Call will be made. If the User chooses to delay the purchase, all the same actions will be taken as if the purchase was confirmed, except the Client Application Call may not be made. If the User cancels the purchase, no further action is taken and the User is returned to the product page where the User Purchase process began.

Client Application Call: After a purchase has been confirmed, a User action through the browser (i.e. clicking a “Print” button) will call and launch the Client application. The call may include relevant session information such as a user login and session ID. After the application is opened, it may perform a Session Validation using the session information, allowing the User to initiate Product Delivery. The call may be carried out as a hyperlink to the Client application, although other mechanisms exist which perform the same function.

Session Validation: Session Validation may include, but is not limited to, validation of User credentials, past and pending purchases, and the printer connection and printer type. Past purchases are purchases that have already been delivered, whereas pending purchases are purchases that are awaiting delivery. The User will be allowed to initiate Product Delivery for any pending purchase. The Session Validation process may occur at any time after the Client application has been launched. When the process begins, User credentials sent from the Client application may be authenticated by the System server, which enables purchase and printer information to be verified and sent back to the Client application.

Session Validation Alternate: In one alternative, Session Validation may not require the User to have a registered account in the system in order to open and initiate product delivery. One implementation may use Server-generated credentials to identify the User and any pending deliveries.

Product Delivery: The Product Delivery process may include, but is not limited to, the Server File Stream and Client Application File Stream processes. This process is able to deliver a processed 3D object file from the System server to a Client 3D printer, where the product will be manufactured.

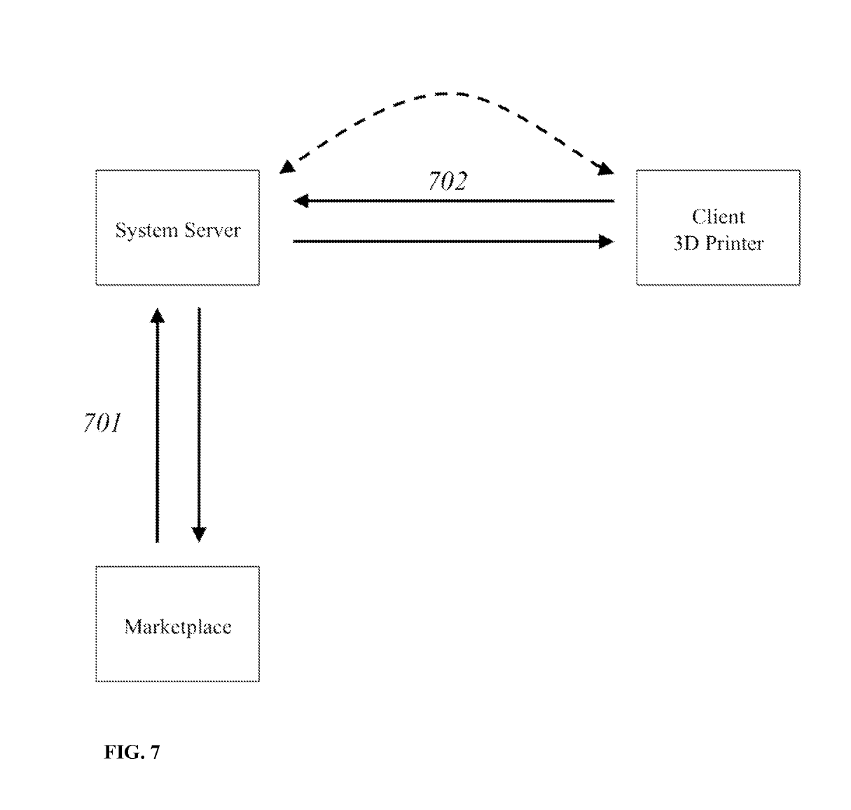

Product Delivery Alternative: FIG. 7 illustrates an alternative to the Product Delivery process that includes an altered Server File Stream (703) process that connects directly to a Client 3D printer, therefore eliminating the need for the Client Application File Stream process. In this configuration, it is assumed that the Client 3D Printer has the ability to interface with the Server File Stream. In one embodiment, after the Purchase User-Interface (701) process, the Client Printer may initiate the connection to the System server with a Session Validation (702). The System server and Server File Stream will interface with software on a Client 3D printer rather than an application being run on a separate Client machine. The Client 3D printer will handle the Server File Stream using methods similar to those in the Client Application File Stream (i.e. using a buffer to store commands), but it will execute them without the need for any additional drivers (e.g. serial drivers). In this embodiment, the Client 3D printer will have the appropriate hardware, such as an Ethernet Port or other network interface, to communicate with the System server. This is a single embodiment of an alternate Product Delivery method, although others are possible.

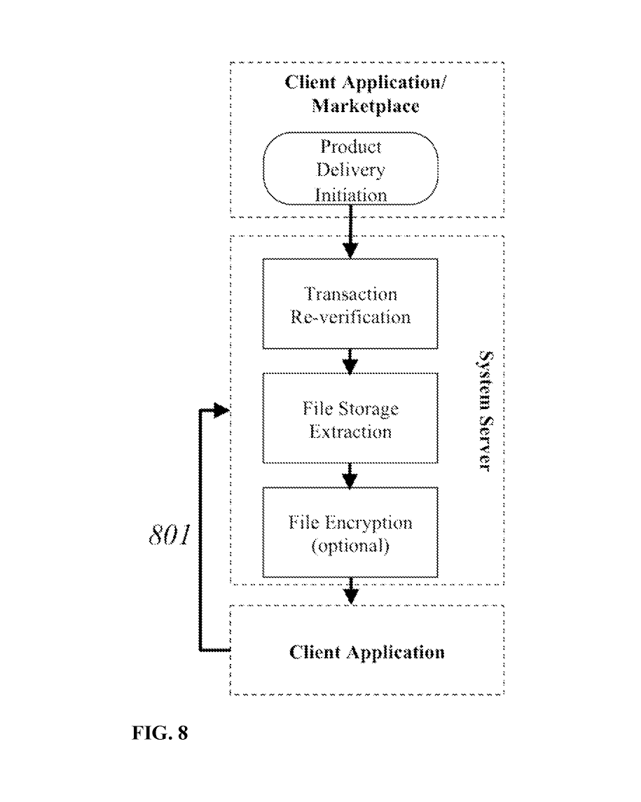

Server File Stream: As illustrated in FIG. 8, the Server File Stream sends the processed 3D object file from the System server to the Client application. This process begins once the Product Delivery of a pending product has been initiated (e.g. through the Marketplace or Client application). Once Product Delivery has been initiated, the product ID is sent to the System server where the transaction is reverified, and the associated 3D object file(s) (processed or unprocessed) can be extracted from storage and sent to the Client application in one or more packages. These packages may or may not be encrypted. If the data is encrypted, the Client application must decrypt it as it is being received. The System server will also be able to receive status updates (801) from the Client application. This will enable the Server to send data packages as the Client application requests them. As well, the printer will be able to send operating data back to the Server for analysis.

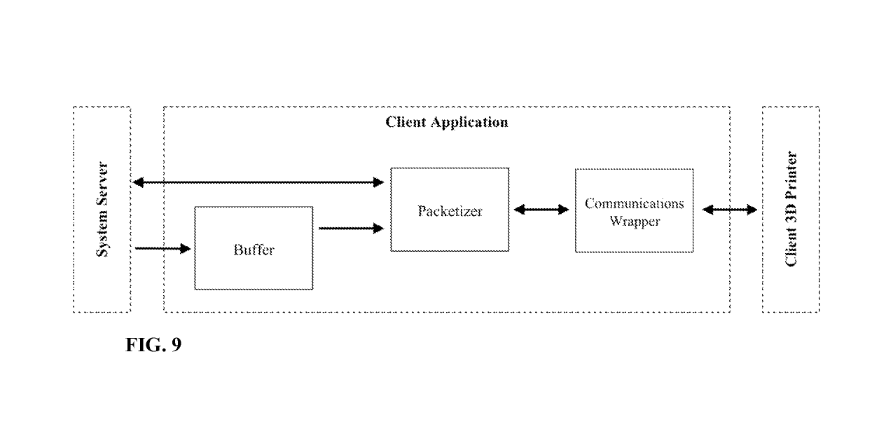

Client Application File Stream: As illustrated in FIG. 9, the Client Application File Stream sends the processed 3D object file from the Client application to the Client 3D printer, where the physical object is manufactured. This process begins after the Client application has retrieved and decrypted (only if encrypted in the Server File Stream process) a packet of data from the Server File Stream. This packet is then stored in local memory (i.e. a buffer), waiting to be streamed to the Client 3D printer. An information packetizer reads the contents of the command buffer and sends parsed instructions one by one to the printer using the communications wrapper. The communications wrapper handles writes and reads from the connection to the 3D printer. Communications wrappers can be written to support connection methods including but not limited to USB and Wifi. Different information packetizers may also be designed for different 3D printers, allowing the Client application to be compatible with multiple 3D printers. The information packetizer may also interpret or handle any responses from the Client 3D printer. This enables real-time responses from the Client 3D printer to be sent back to the Client application, and thus to the System server, which makes it possible to track the progress of the Product Delivery and manufacturing process. After all packets for a single product have been sent to and executed by the Client 3D printer, the Client Application File Stream process is complete.

Marketplace Alternative: Although the System herein is represented as an online marketplace where Users make purchases (i.e. financial transactions), other embodiments are possible that simply include the providing of digital files and services through other methods.

What is claimed is:

1. A method for delivering 3D object files from an online server to a client 3D printer, the method comprising:
sending a listing of one or more 3D object files for display to a user at a client machine;
receiving from the client machine a user selection of one or more 3D object files;
in response to receiving the user selection, establishing a network connection between the online server and the client 3D printer; and
streaming the selected 3D object file from the online server to the 3D printer in a format supported by the 3D printer.

2. The method of claim 1, wherein the selection is received from a native application on the client machine.

3. The method of claim 1, wherein the selection is received from a web page.

4. The method of claim 1, wherein the streaming is conditional upon a user associated with the client machine being signed in to the online server using a registered account.

5. The method of claim 1, wherein the 3D object selection is followed by a monetary transaction.

6. The method of claim 1, wherein the user selection further comprises one or more key manufacturing parameters and information for processing or reprocessing the 3D object file.

7. The method of claim 1, further comprising:
validating a user identity associated with the client machine and access rights to the one or more 3D object files before establishing the network connection to the 3D printer.

8. The method of claim 1, wherein the network connection between the online server and the 3D printer is facilitated by a client application that communicates with the online server and the 3D printer.

9. The method of claim 8, wherein the client application is opened after the user selection without any additional action required by the user.

10. The method of claim 1, wherein the network connection is directly between the online server and the client 3D printer.

11. The method of claim 1, wherein the network connection between the online server and the 3D printer is encrypted.

12. A method for collecting, organizing, and processing of 3D object files and related information, the method comprising:
receiving 3D object files;
receiving a set of printing parameters associated with the received 3D object files;
processing the received 3D object files to produce a plurality of formatted 3D object files, each formatted 3D object file converted to a format based on the received set of printing parameters and a set of capabilities for a different 3D printer of a plurality of 3D printers; and
storing the plurality of formatted object files.

13. The method of claim 12, wherein the 3D object files and the set of printing parameters are received from a web page.

14. The method of claim 12, wherein the 3D object files and the set of printing parameters are received from a native application on the client machine.

15. The method of claim 12, wherein a received 3D object file is uploaded in an organization in connection with a group of one or more other 3D object files.

16. The method of claim 12, wherein the processing is performed by an online sever.

17. The method of claim 12, wherein the processing is performed by a native application on the client machine.

18. The method of claim 12, wherein the processing is performed by a client 3D printer.

19. The method of claim 12, wherein the set of printing parameters comprises one or more manufacturing parameters.

20. The method of claim 12, wherein the 3D object file is further processed based on one or more parameters previously stored on the online system and used to process a plurality of different 3D object files.
